(19) United States
(12) Patent Application Publication
(10) Pub. No.: US 2011/0019447 A1
(43) Pub. Date: Jan. 27, 2011

(54) Solar motor generator power converter

(76) Inventor: Edward DeForrest Olsen, Morgan, UT (US)

Correspondence Address: Edward DeForrest Olsen, 960 South Morgan Valley Drive, Morgan, UT, 84050, US

(21) Appl. No.: 12/460,862

(22) Filed: Jul. 27, 2009

(51) Int. Cl. H02M 7/54; H02K 47/04

(52) U.S. Cl. 363/102; 310/113

(57) ABSTRACT

Modern solar voltaic power conversion for grid compatible usage requires employing complicated active electronic systems designed to control connection, conversion, regulation and safety functions that are absolutely necessary for co-generation applications. This invention inherently and passively performs all of those functions, delivering fully regulated, compatible and fail safe alternating current suitable for supplementing the electrical grid at virtually any point of use and does not use any active electronic devices. This invention dramatically simplifies and improves the art of converting solar voltaic power to common grid power by utilizing an ingenious “Motor-Generator” combination of a common direct current motor and a common induction motor; Two very old devices that have been in common use for over one hundred years.

### CROSS-REFERENCE TO RELATED APPLICATIONS

Not Applicable

### STATEMENT REGARDING FEDERALLY SPONSORED RESEARCH OR DEVELOPMENT

There is no Federally Sponsored Research or Development applicable to this invention.

### REFERENCE TO SEQUENCE LISTING, A TABLE, OR A COMPUTER PROGRAM LISTING COMPACT DISC APPENDIX

Not Applicable

### BACKGROUND OF THE INVENTION

At the present time if one desires to use solar electrical power at a home or business or other location where electrical power is commonly used, it requires the use of very complicated and sophisticated, expensive electronic devices.

Solar voltaic power comes from an installed bank of solar panels as unregulated direct current. The voltage level and current delivered depends upon the number and configuration of solar panels used. It also depends on weather patterns, i.e. passing clouds.

Because of variations in size and performance during normal operation conversion devices must have built into them active sensing and dynamic adjusting capabilities for frequency, voltage, current, phase relationships, paralleling and other parameters that must be monitored and continuously adjusted. Safety “lockout” interlocks are also required to prevent the system from “Islanding.” This is a dangerous condition where grid power fails but an individual solar power system keeps working. If this happens it can inadvertently energize a portion of the grid that is thought to be de-energized. This is a very dangerous situation for line workers trying to repair a problem.

All of these parameters are monitored and controlled in a modern solar conversion device which is why they are so complicated and expensive.

I have discovered that by using a certain and specific configuration of motor-generator, all of these parameters are naturally and safely controlled by the inherent physical nature of the device. Upon discovering this it follows that this would make for a much safer, less costly and much less complicated conversion system that virtually controls itself without using any sort of complicated electronic sensors, adjustors or lockouts. The Motor-Generator does it all naturally if it is configured correctly.

### BRIEF SUMMARY OF THE INVENTION

The purpose of this invention is to perform direct conversion of unregulated photovoltaic, solar panel generated direct current electrical power to regulated Alternating Current to be used to supplement the electrical grid at the point of use.

This device inherently and passively performs all of the safety and regulation functions to make it completely compatible with the power grid at any point of use location, with a virtually unlimited number of possible supply points where this invention could be introduced to provide supplemental power as desired or needed.

The inherent regulation and safety control is achieved by the use of a motor generator pair composed of a common type Direct Current motor mechanically coupled to a common type Alternating Current Induction motor.

The device operates by taking advantage of the natural characteristics of an induction motor when connected to AC power but mechanically driven by a separate motor to a higher speed than the induction motor's normal operating speed. When this happens the induction motor changes to a generator whose output conforms exactly to the characteristics of the grid to which it is connected.

The device “pushes” clean, regulated power onto the grid at the point of use when the solar generated DC current is sufficient to force the induction motor into generator mode. The amount of power generated is directly proportional to the intensity of the sun. All variations and irregularities of solar panel output are inherently compensated for by the physical nature of the system without the need for complex electronic control systems. Should the grid lose power the system will immediately stop generating as well thereby providing direct and failsafe operational control by the grid it is connect to.

### BRIEF DESCRIPTION OF THE DRAWING

FIG. 1. “Invention Block Diagram,” shows the configuration of the invention.

The block labeled, “Solar Panel Bank,” represents a set of photo voltaic solar panels that have been installed in a suitable location to collect sunlight. The precise size and configuration is a choice of the user and size of application intended. The electrical output of the Solar Panel Bank is directly connected to the electric input of the Direct Current drive motor.

The Block labeled, “Direct Current Drive Motor,” represents a common type Direct Current motor. It is coupled to the Alternating Current Induction Motor/Generator via a suitable coupling, such as a belt and pulleys or a mechanical axle to axle coupling such that their rotors turn together via the coupling.

The Block Labeled, “Alternating Current Induction Motor/Generator” Represents a common induction motor that is chosen to be compatible in capacity and rotation speed with the Direct Current Drive motor.

The block labeled, “Local Point of Use Grid,” represents the electrical connection between the Alternating Current Induction Motor to a local grid connection point set aside for that purpose at the point of use.

### DETAILED DESCRIPTION OF THE INVENTION

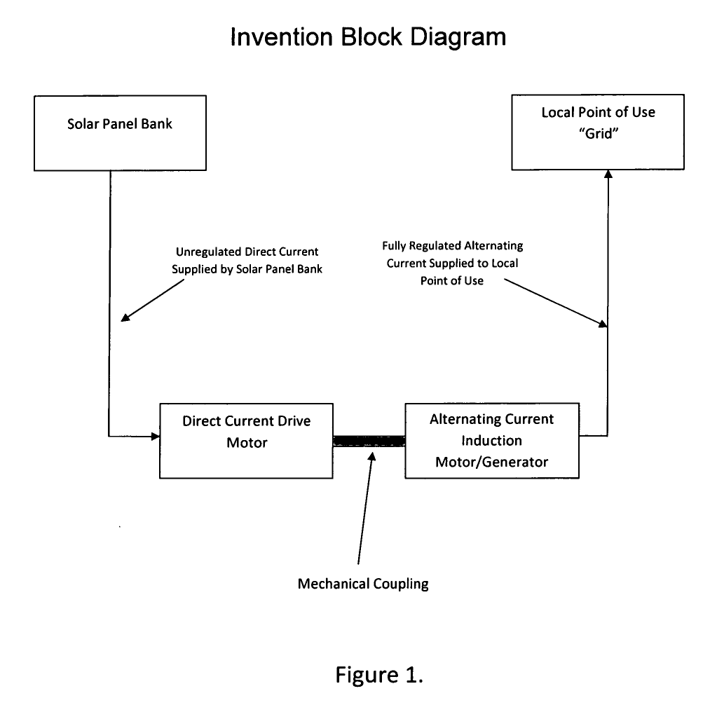

This invention consists of the combination of items shown assembled in the particular order illustrated in FIG. 1.

The invention consists of assembling the direct current motor such that it receives its power from an appropriately sized bank of photovoltaic solar panels and is mechanically coupled to an appropriately sized common induction type Alternating Current motor. The electrical power connection of the induction motor is connected to a live portion of the local electrical power grid at the point of usage, such as a common 220VAC receptacle in a house or other similar receptacle or even directly wired in and permanently installed in a commercial building or other similar location, of course subject to electrical code requirements.

When configured as described above the induction motor will initially behave as a common induction motor would be expected to behave when connected to the power source. That is to say its rotor will start to turn then come up to speed and rotate at a predetermined RPM slightly less than synchronous speed considering the number of poles in the motor's stator windings and the frequency of the source point alternating current. It turns at slightly lower speed than synchronous because of “slip” required between the actual rotor speed and the apparent rotational speed of the magnetic field generated by the stator windings of the induction motor. The armature or rotor of the induction motor has aluminum or copper conductors structured much like a hamster's exercise wheel and is in fact commonly called a “squirrel cage rotor.”

The copper conductors are electrically insulated from but embedded in an iron core that makes up the bulk of the rotor's mass. The stator's rotating magnetic field cuts across the squirrel cage rotor conductors and creates a dynamic magnetic field in the rotor that follows the armature's rotating field, but at a slightly lower speed.

When the DC drive motor increases the RPM of the induction motor to synchronous speed the action of the induced magnetic field in the squirrel cage rotor ceases. As the DC drive motor further increases the rotation speed past the point of synchronous the induced magnetic field action in the rotor once again resumes but in such a way that it transfers energy to the stator that manifests itself as electrical power output that is “pushed” into the live source of power to which the induction motor is electrically connected. Operating in this manner causes an inherent and automatic synchronization of the induction motor to the frequency of the point of use source of power. As the DC motor responds to power input from the solar panels the AC induction motor automatically and inherently generates power at the same frequency as the grid to which it is connected and in direct proportion to the amount of power being supplied by the solar panels at any given moment in time. The generated AC power is pushed onto the local point of use power grid and acts as an additional source of power, reducing the power demand on the local point of use grid by the same amount that the induction motor is supplying due to the energy coming from the bank of solar panels.

While in this mode of operation the induction motor automatically and inherently responds to variations in the amount of power being transferred from the bank of solar panels due to passing clouds and other such events by varying its AC electrical output level accordingly and dynamically while staying electrically locked on frequency. Should the solar input cease because of nightfall, the induction motor automatically and inherently reverts to operating as a motor and keeps the system locked on frequency ready to generate AC power the instant solar power becomes available.

Since the AC induction motor's stator must be energized by the point of use AC source of power, if the local power grid goes down this device immediately stops generating power because it would not receive the power it needs from the active grid to maintain its own dynamic stator magnetic field. That is the natural feature of this device that makes it failsafe. It cannot generate power without being connected to a grid that is already live.

1. An electro-mechanical motor-generator based appliance that converts unregulated direct current electrical power supplied by photovoltaic solar panels to fully compatible and regulated Alternating Current for application to a point of use local section of the electrical power grid or any subset thereof.

2. The device of claim 1 is a specifically configured Motor Generator set where the driving motor which is electrically connected to the solar panel power source is a common Direct Current Motor and the driven generator is a common Alternating Current induction type motor with its electrical power leads connected to a point of use location of the electrical power grid.

3. The device of claim 1 takes advantage of its own natural and characteristic electro-mechanical behavior when configured as described in claim 2, to provide fully automatic regulation and supply of pure sine wave, clean alternating current power of correct frequency to a point of use location of the electrical power grid without the use of complex electronic control devices.

4. The device of claim 1 takes advantage of its own natural and characteristic electro-mechanical behavior when configured as described in claim 2 to electrically parallel itself to the electrical frequency of the local point of connection to the electrical power grid without the need for complex electronic or manual devices specially designed for the purpose of electrically paralleling the device with the grid prior to electrical connection.

5. The device of claim 1 takes advantage of its own natural and characteristic electro-mechanical behavior when configured as described in claim 2 to provide simple and reliable failsafe operation that is passively controlled by the dynamic operating characteristics of the electrical grid or subset of the electrical grid to which it is connected. The device will deliver clean regulated power to an active powered up electrical grid but will inherently cease generating electrical power immediately upon loss of grid power without the use of any complex electronic control devices. This device can only supplement an already fully operational electrical grid. It cannot operate as a standalone generator.

6. The device of claim 1 when configured as described in claim 2 is scalable with the ideal size for point of use connection in a private home environment being about 2-5 Kilowatts in capacity. Any number of these devices can be connected to a grid at any number of subset points such as individual homes resulting in the power demand on the grid transmission system being reduced while the transmission grid still maintains positive control of all the devices connected to it.
